(19) United States
(12) Patent Application Publication
(10) Pub. No.: US 2013/0047793 A1
(43) Pub. Date: Feb. 28, 2013

(54) LOOSENING TOOL

(71) Applicants: Johnny Dene Hamby, Boca Raton, FL (US); Donny Gene Hamby, Boca Raton, FL (US)

(72) Inventors: Johnny Dene Hamby, Boca Raton, FL (US); Donny Gene Hamby, Boca Raton, FL (US)

(21) Appl. No.: 13/599,084

(22) Filed: Aug. 30, 2012

Related U.S. Application Data
(60) Provisional application No. 61/529,498, filed on Aug. 31, 2011.

(51) Int. Cl. B25B 13/48

(52) U.S. Cl. 81/176.15

(57) ABSTRACT

A tool for loosening a rotatable, tightenable object having a gripping protrusion consists of a center beam, a handle with two stabilizers, and a rotary beam with two torque rods. The center beam is attached perpendicularly to the handle (at the center beam's upper end) and to the rotary beam (at the center beam's lower end). Stabilizers attached to the ends of the handle allow a better grip for applying torque. Torque rods attached to the ends of the rotary beam press on the sides of the gripping protrusion in order to produce a torque at the center of rotation when a person applies a rotary force on the handle. The tool is constructed out of a single-molded durable material and is used to loosen objects that are over-tightened due to external factors (e.g. heat, moisture, chemical exposure) and objects that are poorly accessible due to nearby external obstacles.

This non-provisional patent application is based on provisional application Ser. No. 61/529,498 filed on Aug. 31, 2011.

### BACKGROUND OF THE INVENTION

1. Field of the Invention

The present invention relates to a tool used for loosening a rotatable, tightenable object with a gripping protrusion.

2. Discussion of the Related Art

It is well known in various arts that a rotatable, tightenable object is often the preferable method of sealing an opening to prevent any entry or exit of any substance through the opening. The most well-known embodiment of this technology is the helical ridge, more commonly known as a thread, in which an opening contains an internal thread (female) and seal contains an external thread (male). The seal is simultaneously inserted and rotated into the opening in order to fasten the threads together. Most threads are constructed to create sufficient friction to prevent linear motion (i.e. pushing or pulling the seal up or down) from being converted to rotary motion (i.e. “unscrewing” the seal). The primary advantage of using threaded seals is that sealing and unsealing are, in theory, relatively fast and require minimal effort.

However, in practical applications, it is well known by most individuals who have used a threaded seal that the seal often becomes overly tightened while sealed in place, which leads to the removal of the seal being extremely difficult. This is because in order to overcome the aforementioned friction (which prevents linear motion from converting to rotary motion), a sufficient rotary torque (applied perpendicularly to the direction of insertion) must be applied. Applying the necessary level of rotary torque often becomes difficult or impossible due to various complications that may include the thread materials experiencing thermal expansion (i.e. expanding when exposed to increased temperature) or becoming deformed due to external factors. Additionally, the application of the rotary torque is often inhibited by the lack of a sufficient point of application. Because the torque applied relies on the force applied and the distance from the point of application to the center of rotation, a point of application may be insufficient if it either doesn't allow a sufficient force to be applied or if it is located too close to the center of rotation, or both. Many threaded seals are designed specifically to allow a sufficient rotary torque to be applied (e.g. by including a gripping ridge on the top, outer surface of the seal on which a person may, in theory, apply a rotational force and remove the seal), however such designs are often tested under perfect conditions (e.g. fastening the seal and them immediately unfastening the seal, which fails to allow sufficient time for external factors to have any effect) and, as a result, the necessary level of rotary torque may still be extremely difficult or impossible to apply after external factors, such as heat and humidity, have altered the seal and opening.

Some of the most predominant examples of this are locking lids and locking knobs used in pool pump and filter apparatuses, such as a locking lid used on pool pump basket housings, or a locking knob used to secure a filter cover to a filter tank body. These specific seals are well known for becoming over-tightened over time due to their constant exposure to many external factors such as sunlight, heat, moisture, and a variety of powerful chemicals. Additionally, these specific seals (used in pool pump and filter apparatuses) are often surrounded by external obstacles such as man-made objects that may include wayward pipes (which do not all conform to any specific, singular design), or walls (such as the external wall of a house or similar structure, next to which most pool pump apparatuses are located), and/or natural objects that may include trees, plants, stones and so forth. Moreover, many of these and other external obstacles often cause injury to a person when he or she tries to unlock the lid or knob of a pool pump or filter apparatus (e.g. hitting one's hand against a sharp object because of the lid's sudden release which occurs after opening an overly-tightened seal). All of these obstacles may, and often do, inhibit a person's ability to adequately grip the locking lid or knob in order to apply the necessary rotary torque. Because of the external factors and obstacles, locking lids and knobs used in pool pump and filter apparatuses are well known for becoming extremely tightly sealed over time and for being in highly inaccessible locations, leading to difficulty and frustration and even injury. As previously mentioned, these types of locking lids and knobs do usually include a gripping ridge or similar design to apply torque; however these means for applying torque regularly fail to be sufficient in cases involving external factors and obstacles.

In light of the shortcomings associated with the abovementioned types of rotatable, tightenable seals, especially those shortcomings associated with locking lids and knobs used in pool pump and filter apparatuses, there remains a need for a loosening tool that may be used to reliably open these types of seals in a wide variety of situations, and that accounts for all of the aforementioned external factors and obstacles, and that furthermore helps to prevent a person from becoming injured when opening a seal.

### OBJECTS AND ADVANTAGES OF THE INVENTION

Considering the foregoing, it is a primary object of the present invention to provide a loosening tool for the purpose of loosening a rotatable, tightenable object with a gripping ridge.

It is still another object of the present invention to provide a loosening tool, as previously described, that allows a person to apply an adequate amount of rotary torque to unlock a seal that has become overly-tightened due to external factors such as heat, moisture and chemical exposure.

It is still another object of the present invention to provide a loosening tool, as previously described, that allows a person to apply an adequate amount of rotary torque to unlock a seal that is located in a difficult-to-access or inaccessible area due to nearby external obstacles such as trees, walls, and plants.

It is still another object of the present invention to provide a loosening tool, as previously described, that reduces or eliminates the risk of injury for a person while unlocking a seal that is located in a difficult-to-access or inaccessible area due to nearby external obstacles by preventing the sudden release associated with unlocking a seal that has been overly-tightened.

It is still another object of the present invention to provide a loosening tool, as previously described, that may be applied to a wide variety of types of seals, locking lids, locking knobs and so forth.

It is still another object of the present invention to provide a loosening tool, as previously described, that is easy to manufacture, package and distribute.

It is still another object of the present invention to provide a loosening tool, as previously described, that requires little or no assembly and that is simple to operate.

These and other objects and advantages of the present invention are more readily apparent with reference to the detailed description and accompanying drawings.

### SUMMARY OF THE INVENTION

The present invention is directed to a tool for loosening a rotatable, tightenable object (such as a locking lid or locking knob) that includes a gripping ridge. The loosening tool is comprised of a central vertical beam (herein referred to as the center beam), a bottom horizontal beam (herein referred to as the rotary beam), and a top horizontal beam (herein referred to as the handle). The central vertical beam is connected to the middle points of both the rotary beam and the handle, forming an I-shaped device. The handle is further comprised of two short, vertical beams (herein referred to as stabilizers) extending downward from both opposing ends of the handle (i.e. one stabilizer at each end of the handle). The stabilizers help provide additional support for a person's hands while applying a rotary torque to the handle, as well as additionally stabilizing and securing the tool's attachment to a hanging rod when being stored. The rotary beam is further comprised of two short, vertical beams (herein referred to as torque rods) extending downward from both opposing ends of the rotary beam (i.e. one torque rod at each end of the rotary beam). The torque rods are used to directly apply force to the gripping ridge of a locking lid or the wings of a locking knob. The torque rods apply a rotational force in parallel with each other to easily unlock a threaded seal. The force (and therefore the torque) applied by the torque rods is dependent on the rotational force delivered by a person to the handle.

All components of the present invention (i.e. the center beam, the handle, the stabilizers, the rotary beam, and the torque rods) are preferably solid, cylindrically-shaped beams. All corners formed by the intersection of two components are rounded in order to eliminate the possibility of a piercing injury. The entire device is preferably manufactured as a single piece using a mold. Additionally, the tool must be constructed of a strong, durable material to prevent fracture or bending during application of a heavy torque. In a preferred embodiment, the loosening tool is manufactured from an epoxy resin or glass-reinforced plastic (fiberglass) or similar materials.

The present invention is operated by lowering the loosening tool over the gripping ridge of a locking lid or the wings of a locking knob. The two torque rods must be placed on opposite sides of the ridge or wings, with the center beam preferably placed directly above the center of rotation of the lid or knob. The user then places his or her hands on the handle and applies a rotary torque about the center of rotation (i.e. the center beam) by pulling with one hand and pushing with the other hand (one direction will lock the seal, the opposite direction will unlock the seal). The loosening tool may be used to completely lock or unlock a seal, lid or knob, or it may simply be used to loosen the threads so that the user can finish locking or unlocking the seal manually.

The present invention serves primarily to overcome the difficulties associated with external factors and external obstacles which affect the seal. External factors may include heat, moisture, sunlight, chemical exposure, and so forth, all of which may contribute to over tightening the seal. Exposure to these external factors is well known to have particularly damaging effects when left for long periods of time without use (i.e. not unlocking and locking the seal for long periods of time). External obstacles may include trees (particularly tree trunks), plants, walls, a variety of man-made objects or equipment, all of which may, when in close vicinity to a seal, such as a pool pump apparatus, cause a person to be unable to apply the necessary rotary torque to unlock the seal of a locking lid or knob. The present invention overcomes these challenges by applying a more powerful torque (thereby overcoming the external factors) and by allowing the torque to be applied at a distance from the locking lid or knob (thereby overcoming the external obstacles). Additionally, many injuries are caused by external obstacles when a person unlocks an over tightened seal, causing a fast, sudden release. These injuries can be particularly problematic for professionals who operate with a large number of such apparatuses on a daily basis. The present invention therefore helps reduce or prevent injury by allowing the user to apply the torque from a distance.

The present invention is designed with specifications specifically to allow it to adapt to a wide variety of types of locking lids, locking knobs, and other seals with some manner of gripping protrusions (e.g. gripping ridge, wings and so forth). The design is simple to manufacture, package and distribute, requires no assembly and is extremely easy to operate, requiring little to no instructions.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view showing the loosening tool.

FIG. 2 is a bottom plan view showing the loosening tool.

FIG. 3 is a perspective view showing the loosening tool unlocking a locking lid with a gripping ridge.

Like reference numerals refer to like parts throughout the several views of the drawings.

### DETAILED DESCRIPTION OF THE PREFERRED EMBODIMENTS

Referring to the several views of the drawings, the present invention is shown and is generally indicated as 10.

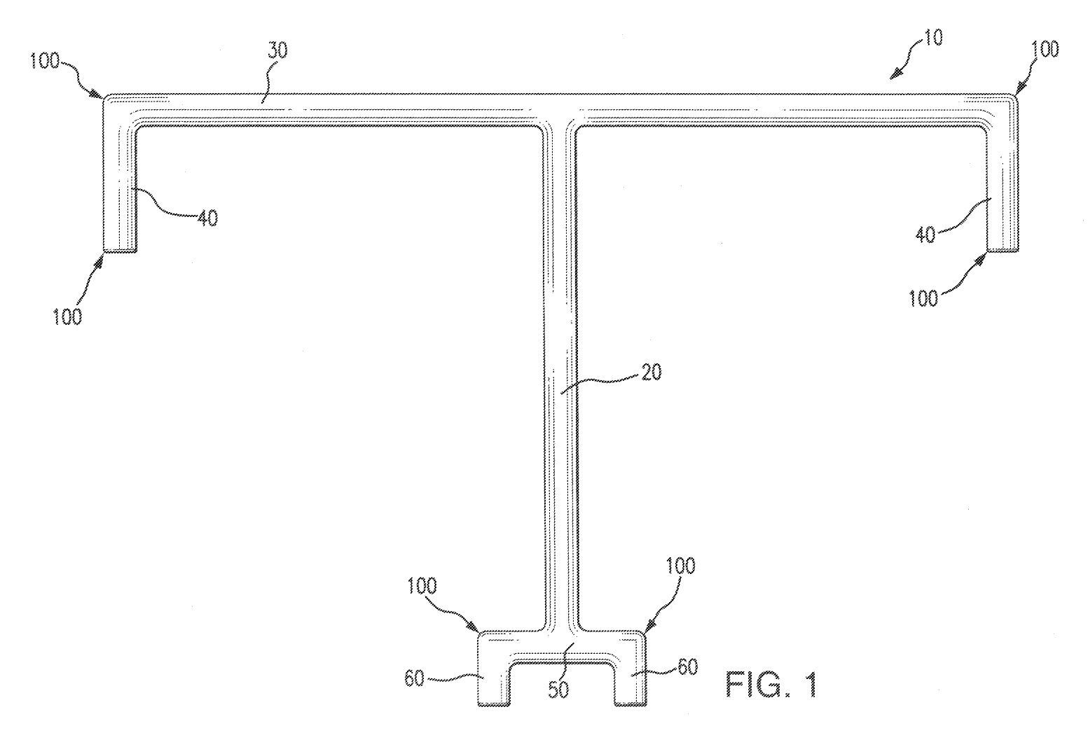

Referring to FIG. 1, the present invention 10 is shown in a side elevational view and consists of a center beam 20, a handle 30, two stabilizers 40, a rotary beam 50, and two torque rods 60. The intersection of any two parts creates rounded corners 100 which are designed to help avoid injury.

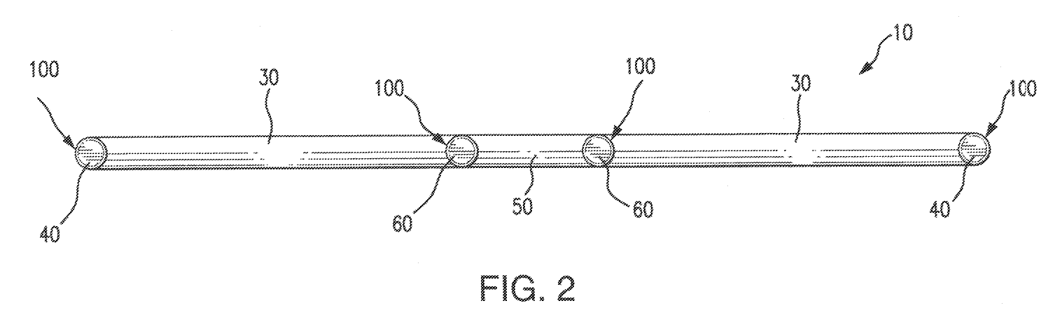

Referring to FIG. 2, the present invention 10 is shown in a bottom plan view. Handle 30 and rotary beam 50 can be seen to be the same width, with rotary beam 50 being significantly shorter than handle 30. Handle 30 is designed to be relatively long in order to increase the torque applied about the center of rotation.

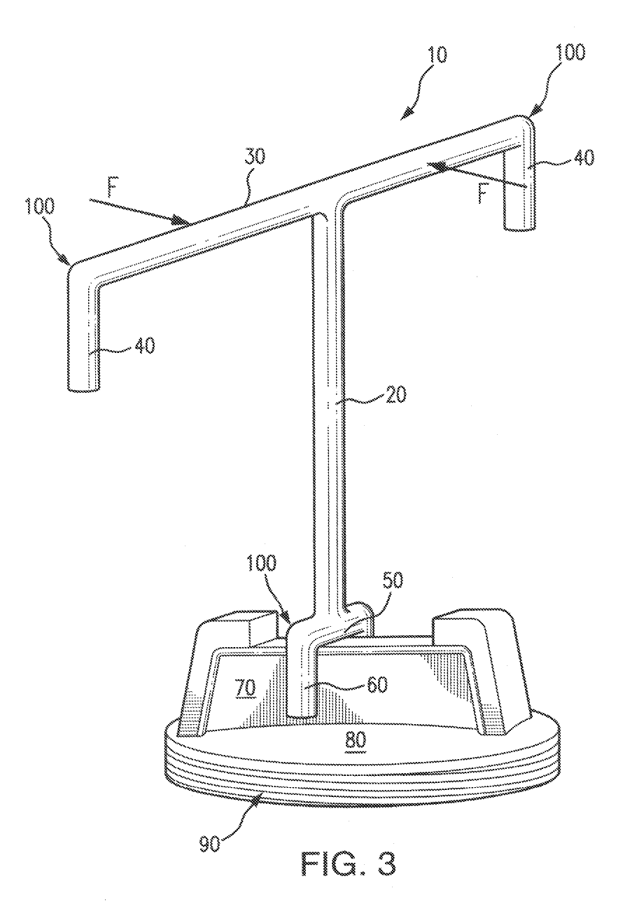

Referring to FIG. 3, the present invention 10 is shown in a perspective view in which the loosening tool 10 is being used to unlock a locking lid 80. Torque rods 60 press against opposite sides of the gripping ridge (or wings or other gripping protrusions) 70. Applying a counter-clockwise force F in the direction shown in the drawings against the outer portion of the handle 30 (i.e. near to the stabilizers 40) will cause a torque about the center beam 20, causing the threads 90 to unlock (i.e. slide against each other as the locking lid 80 moves upwards).

All components of the present invention 10 (i.e. the center beam 20, the handle 30, the stabilizers 40, the rotary beam 50, and the torque rods 60) are solid, cylindrically-shaped beams.

In a preferred embodiment, the present invention 10 is manufactured as a single piece using a mold, and from a material to prevent fracture or bending during application of a heavy torque, preferably an epoxy resin or glass-reinforced plastic (fiberglass) or similar material.

While the present invention has been shown and described in accordance with a preferred and practical embodiment thereof, it is recognized that departures from the instant disclosure are fully contemplated within the spirit and scope of the present invention.

What is claimed is:

1. A tool for loosening a rotatable object, said tool comprising:
a center beam having a top end and a bottom end;
a handle extending from the top end of said center beam, and said handle including a first stabilizer and a second stabilizer for being gripped by the hands of a user;
a rotary beam extending from the bottom end of said center beam;
a first torque rod and a second torque rod on said rotary beam, said first and second torque rods being structured and disposed for grasping the rotatable object; and
whereby applying rotational force to said first and second stabilizers causes said first and second torque rods to rotate the rotatable object.

2. The tool as recited in claim 1 wherein said handle extends perpendicularly from the top end of said center beam.

3. The tool as recited in claim 1 wherein said tool is constructed of a single-molded material.

4. The tool as recited in claim 3 wherein said single-molded material is fiber-reinforced plastic.

5. The tool as recited in claim 1 wherein the angle at which each of said first and second stabilizers extends from said handle is rounded off.

6. A tool for loosening a rotatable object having a gripping protrusion, said tool comprising:
a center beam having a top end and a bottom end;
a handle extending from the top end of said center beam, and said handle including a first stabilizer and a second stabilizer for being gripped by the hands of a user;
a rotary beam extending from the bottom end of said center beam;
a first torque rod and a second torque rod on said rotary beam, said first and second torque rods being structured and disposed for grasping opposite sides of the gripping protrusion on said rotatable object; and
whereby applying rotational force to said first and second stabilizers causes said first and second torque rods to press against the opposite sides of the gripping protrusion, thereby causing the rotatable object to rotate.

7. The tool as recited in claim 6 wherein said handle extends perpendicularly from the top end of said center beam.

8. The tool as recited in claim 6 wherein said tool is constructed of a single-molded material.

9. The tool as recited in claim 8 wherein said single-molded material is fiber-reinforced plastic.

10. The tool as recited in claim 6 wherein the angle at which each of said first and second stabilizers extends from said handle is rounded off.

11. A single-molded tool for loosening a rotatable object having a gripping protrusion, said tool comprising:
a center beam having a top end and a bottom end;
a handle extending from the top end of said center beam, and said handle including a first stabilizer and a second stabilizer for being gripped by the hands of a user;
a rotary beam extending from the bottom end of said center beam;
a first torque rod and a second torque rod on said rotary beam, said first and second torque rods being structured and disposed for grasping opposite sides of the gripping protrusion on said rotatable object; and
whereby applying rotational force to said first and second stabilizers causes said first and second torque rods to press against the opposite sides of the gripping protrusion, thereby causing the rotatable object to rotate.

12. The tool as recited in claim 11 wherein said handle extends perpendicularly from the top end of said center beam.

13. The tool as recited in claim 11 wherein said single-molded material is fiber-reinforced plastic.

14. The tool as recited in claim 11 wherein the angle at which each of said first and second stabilizers extends from said handle is rounded off.
